(19) United States
(12) Patent Application Publication
(10) Pub. No.: US 2007/0174296 A1
(43) Pub. Date: Jul. 26, 2007

(54) METHOD AND SYSTEM FOR DISTRIBUTING A DATABASE AND COMPUTER PROGRAM WITHIN A NETWORK

(76) Inventors: Andrew Gibbs, Yuba City, CA (US); Stephanie Gibbs, Yuba City, CA (US)

Correspondence Address: MAIER & MAIER, PLLC, 1000 DUKE STREET, ALEXANDRIA, VA, 22314, US

(21) Appl. No.: 11/624,014

(22) Filed: Jan. 17, 2007

Related U.S. Application Data
(60) Provisional application No. 60/759,008, filed on Jan. 17, 2006.

(51) Int. Cl. G06F 17/30

(52) U.S. Cl. 707/10

(57) ABSTRACT

A system and method of distributing one or more of a software application, a database, and a document search and retrieval means across a network of two or more servers. Individually, or collectively, one or more servers are accessible by a client computer that has permission to access the network. In an exemplary configuration, the present invention is comprised of an application service distributed between one or more host servers on the Internet and one or more appliance servers and clients located behind a network security access point, with one or more authorized clients and the appliance in communication across the network security network access point with one or more ASP host servers on the network.

### PRIORITY

This application claims priority under 35 U.S.C. 119(e) to U.S. Provisional Application No. 60/759,008, filed Jan. 17, 2006, the content of which is hereby incorporated by reference in its entirety.

### FIELD

The present invention generally relates to systems and methods of distributing software applications, databases and document search and retrieval means across a network.

### BACKGROUND

The background art cuts across a number of technology areas, specifically, database search engines and web distributed software. The description of background art will begin with search engines.

Using the Internet to conduct searches upon a searchable database is well-known. Google and Yahoo, for example, are prime examples of Internet search engines that allow users to access various databases and receive a search results set. In many cases, the search engine includes an index created by reading the contents of the databases. Even if multiple databases are accessed, the contents are selected based on retrieval instructions placed upon the databases by the index.

US 20030220934 A1 (Hejl) teaches transforming categories from multiple lists into a unified list of search results. U.S. Pat. No. 5,659,732 (Kirsch) teaches a method for searching a plurality of databases which are distributed and accessible to a client through one or more search servers and combines and computes the relevancy ranking of a plurality of lists of search results at the client. U.S. Pat. No. 5,864,846 (Vorhees et al.) teaches a computer-implemented method for facilitating searches by combining search result documents from separate search engines in response to a query into one single integrated list so as to produce a ranked list of pages. U.S. Pat. No. 6,701,314 (Conover et al.) teaches a system for automatically cataloguing documents located in multiple heterogeneous repositories.

Search engines are being incorporated into stand-alone servers that can be installed at any location. These servers containing installed software applications are called appliances. An example of a search appliance is the Google Appliance that incorporates the search technology generally encountered in the Internet version of Google, but which allows the user to install their private collection of documents for indexing by the Google software. After indexing, the user may search their private document collection and receive results as if they had actually searched Google. In the example of the Google Appliance, the user may even access the Internet version of Google and conduct an Internet search and deliver a unified interface containing the search results from disparate databases. Put another way, a search appliance may be used as a meta search engine that combines results.

US 20030046379 (Nakamura et al.) teaches an application service executed by an Internet appliance. U.S. Pat. No. 6,965,935 (Diong) teaches an Internet appliance communicating with a central server and a means to exchange data between the appliance and central server.

Software applications made accessible via the Internet by the software publishers called application service providers (ASP) are well known. These ASP models allow users to access a software application residing on a remote server as if it was installed on their personal computer. One example of a typical ASP model is Salesforce.com sales force automation software.

ASP software models typically allocate disk space on the ASP server to record users' proprietary information such as personal account information, user preferences, notes, lists or other data. The ability to store and retrieve this data is provided via Internet access to the ASP server. The software is wholly contained on the ASP server and is vulnerable to attack or unauthorized access by computer hackers.

In addition, there are instances when such user created data may be considered too confidential or sensitive to be stored on a server not managed or controlled by the creator or employer of the user data, or when access to such data is restricted to authorized persons either by policy or law. In such instances, the storage of such data upon a publicly accessible ASP first server jeopardizes the secrecy of the data, and is not only discouraged, but may be mandated. Regardless of the security level offered by the ASP first server manager, it has been shown that third parties tasked with protecting secret data are unable to provide the absolute assurances and safeguards necessary to protect the data. Examples of third party companies that may have failed to safeguard secret data entrusted to them include at least: (a) Lexis Nexis ChoicePoint security breach that exposed dossiers of personal information to public access and (b) the security breach at CardSystems Solutions that allowed reported exposure of the identities of nearly 40 million MasterCard and Visa credit card holders as well as other similar breaches.

In the field of intellectual property and patents, information related to inventions that have not been filed as patent applications should be of a confidential nature. Unauthorized access to invention disclosures or invention records could financially devastate even the largest corporations, and, therefore, it is highly advisable that it is guarded. For example, data considered too confidential to store on a publicly accessible ASP first server may include invention disclosures and non-public pending patent applications of an enterprise. In the medical field, a collection of medical patient records within a hospital may be mandated by law to be kept confidential.

ASP software models require the client user to have faith in that the host software server has implemented adequate means to protect confidential client-generated data from unauthorized access. In some cases, the generated information is either deemed too sensitive to record on an ASP host's server or is confidential data that is barred from being recorded on a server that resides outside of the client user's protected network. For example, confidential or highly sensitive data on an ASP host are contraindicated when recording unpublished patent or invention disclosure information or when recording medical patient information to comply with certain policies or regulations. In these instances, a traditional ASP model does not provide for a client to access only certain programs of the software, or record only certain data on a server located within a protected access point while still accessing the remainder of the software programs on the primary ASP host server.

### SUMMARY

At least one exemplary embodiment of the present invention, a system for distributing more than one concept database in a network is disclosed. The system may include a network accessible to one or more clients having a secure access point. Also, the system may include at least one host server accessible to the client via the network where the at least one host server has a concept database and at least one of a database, a software application, an electronic document collection and a search functionality. Moreover, the system may include at least one local server for storing user created data determined to be sensitive behind the secure access point accessible to the client via the network. The at least one local server may have a distributed version of the concept database and at least one of a database, a software application, an electronic document collection and a search functionality, where the client may have trans-secure-access point communication with the at least one host server. Further, the at least one host server may be operatively interfaced with the at least one local server.

In another exemplary embodiment, a method of distributing a concept space within a network is disclosed. The method may include providing at least one host server containing at least one primary document collection and providing a first concept space contained on the at least one host server. The first concept space may be the result of indexing the at least one primary document collection. Moreover, the method may include providing at least one client server having at least one secondary document collection and providing one or more second concept spaces substantially similar to the first concept space. The one or more second concept spaces may be contained on the at least one client server and the at least one secondary document collection may be indexed against the one or more second concept spaces.

In yet another exemplary embodiment, a method of searching a plurality of databases which are distributed and accessible to a client through one or more search servers is disclosed. The method may include accessing a first search server containing a first document collection having one or more first databases and may contain a first semantic vector space computed by indexing the first document collection. The method may also include accessing one or more second search servers containing at least one second document collection having one or more second databases. The one or more second search servers may also have one or more distributed versions of the first semantic vector space where the at least one second document collection may be indexed against the one or more distributed versions of the first semantic vector space. Additionally, the method may include submitting a search query from a client to the first search server and the one or more second search servers and may include returning one or more first relevancy-ranked search result sets to the client from the one or more databases on the first search server computed at the first semantic vector space. The method may further include returning one or more second relevancy-ranked search result sets to the client from one or more databases on the one or more second search servers computed at the one or more distributed versions of the first semantic vector space.

### BRIEF DESCRIPTION OF THE DRAWINGS

For a more complete understanding of the exemplary embodiments of the present invention and the advantages thereof, reference is now made to the following descriptions taken in conjunction with the accompanying drawings, in which like reference numerals designate like elements, wherein:

FIG. 1 shows a flow chart with an exemplary embodiment of a client computer accessing a software program remotely located in a network.

FIG. 2 shows a flow chart with an exemplary embodiment of a client computer accessing more than one server remotely located in a network, each server containing a copy of all or part of a software program.

FIG. 3 shows a flow chart with an exemplary embodiment of a client computer accessing two servers.

FIG. 4 shows a flow chart with an exemplary embodiment of a client computer accessing two servers, each of the two servers containing non-duplicative components of a single software program.

FIG. 5 shows a flow chart with an exemplary embodiment of a client computer accessing multiple servers in order to conduct a simultaneous search of the databases stored on the different computers.

FIG. 6 shows a flow chart with an exemplary embodiment of a search being conducted upon a concept database copied upon multiple servers with the search results from each server being merged into a single search results list.

FIG. 7 shows a flow chart with an exemplary embodiment of a client computer accessing one appliance server located on the client side of a firewall and a second server located on the public side of the firewall.

FIG. 8 shows a flow chart with an exemplary embodiment of a search being conducted from the client computer upon a distributed concept database, non-duplicative document collections and a single merged search results list.

FIG. 9 shows a flow chart with another exemplary embodiment of a search being conducted from the client computer upon a distributed concept database, non-duplicative document collections and a single merged search results list.

FIG. 10 shows a flow chart with an exemplary embodiment of distributed software having a user access features via the Internet.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

One embodiment can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus or device.

The medium can be electronic, magnetic, optical, electromagnetic, infrared, or semiconductor system (or apparatus or device) or a propagation medium. Non-limiting examples of a computer-readable medium include a semiconductor or solid state memory, magnetic tape, a removable computer diskette, a random access memory (RAM), a read-only memory (ROM), a rigid magnetic disk and optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to rescue the number of times code must be retrieved from bulk storage execution.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

At least one embodiment herein may be implemented via a distributed computing environment, such as the Internet, where tasks are performed by remote processing devices that are linked through a communications network. Those skilled in the art will also appreciate that other communications systems can be used, such as direct dial communication over public or private telephone lines, a dedicated wide area network, or the like. In the distributed computing environment, computer-executable instructions and program modules for performing the features of embodiments may be located in both local and remote storage devices.

At least one exemplary embodiment of the present invention may provide for a system and method of distributing at least one of a software application, a database, and a document search and retrieval means across a network of two or more servers. Individually, or collectively, one or more servers are accessible by a client computer that has permission to access the network. The software application may be accessible to the client computer via a web server, with all of the programs of the software application residing on a remotely located first server, or with some or all of the programs of the software application residing on one or more of the servers connected directly or indirectly within the network.

At least one exemplary embodiment of the present invention may combine the distribution of a software application, a database and a search means together as a system distributed across multiple servers within a network so that a user may elect what elements of the system should reside on a server that may be located behind a defined secure access point, while still realizing any cost and efficiency benefits of distributed software applications and databases.

An exemplary purpose of distributing a database across more than one server is that it may provide the user with the ability to locate one server behind a secure access point thereby protecting data deemed confidential or sensitive (e.g., in local document collection) from a public domain, yet still the user may have access to the necessary publicly accessible document collections on a remote server. For example, by putting the control of access to this proprietary information, as well as the management of the confidential data, under the control of a software licensee behind a secure access point or firewall, the responsibility to maintain data integrity is shifted from the ASP provider to the user. The results of searching both local and remote databases can be a single results list that relevancy ranks documents searched in response to a search query.

Another exemplary purpose of distributing a computer program across more than one server may be to allow a client to access a primary server containing the primary functionality of the software application, yet it may also allow the client to access the programs of the application residing on a local server, and to record private confidential or sensitive information on the programs located on the local server, such local server located behind a secure access point or firewall that separate the local server from the primary server on a network.

Yet another exemplary purpose of distributing a database across more than one server, for example, when the database is a latent semantic concept space that may be created on one server using a latent semantic pseudo-vector matrix of a document collection, may be to allow a reasonable facsimile of the concept space to be distributed to one or more second servers. The one or more second servers may then contain a latent semantic pseudo-vector matrix of a document collection on each respective server such that a search query may be applied to one or more servers and will return a single document list in a relevancy ranked order. Relevancy rank may be determined by comparing searched documents to the first concept database or a distributed version of the first concept database.

At least one exemplary embodiment that can provide substantially similar distributed copies of a first concept database may overcome potential problems associated with latent semantic analysis technologies. One potential problem associated with deploying a latent semantic analysis search engine technology is that a threshold number of documents may have to initially reside on the server so that the semantic indexing process can analyze the many document concepts in order to develop a relevancy relationship between the documents. If, for instance, only single documents were entered into a database, the semantic index of these documents would probably contain few concepts, and, therefore, may be unpredictable in ranking the relevancy of these documents against each other in response to any particular search query. Exemplary embodiments may overcome any such limitation by providing for a reasonable facsimile of a concept database created by indexing a more extensive collection of documents that may be installed on a second server. When, for example, a single document is indexed against the facsimile of the concept database, it will obtain a relevancy ranking against a search query similar to the relevancy ranking it would achieve had that single document been included in the more extensive collection of documents used to create the first concept database.

Exemplary embodiments of the present invention may compute the relevancy of one or more search results listed against a distributed semantic concept database at each search server prior to delivering to the client a single results list that may be formed by combining two or more lists containing documents the may have already been scored by the semantic vector space. At least one exemplary embodiment may provide for calculating the vector of each document against a single semantic vector space index which, in exemplary embodiments, can eliminate the need for the application of a secondary computation being performed on the multiple results of the multiple list so as to conform to a form and format that allows merging of the lists into a single page.

A single index of metadata for each document, which defines the effective relationship between the documents based on keyword ranking, may not have to be created and stored in exemplary embodiments of the present invention. Also, embodiments of the present invention may provide a more beneficial method of mapping heterogeneous repositories against a single semantic vector space without establishing a relevancy between the documents until after a search query is performed. The search query itself may become a dynamic mapping tool that consistently establishes the relevancy between each document based on the query, even if the documents are located in different repositories.

Moreover, exemplary embodiments may: (a) call for a trans-firewall communication between an application service host and an ASP appliance; and (b) allow the user to flexibly chose what programs of the ASP solution will reside on an appliance on the protected side of a firewall, and which corresponding programs of the ASP solution will be invoked from the ASP host server. Further, exemplary embodiments may not require a user to control the appliance communication from a central server that disallows direct communication with the appliance solely from the client and appliance side of a protected access point or firewall. Yet further, at least one exemplary embodiment may provide for a server remotely located relative to an ASP server, and which may contain: (a) a distributed web-based software application; (b) at least one database residing on the appliance server and ASP server containing at least one different collection of documents; (c) a latent semantic concept database against which to index the different collections of documents; and (d) a method of combining the search results from multiple servers into a unified relevancy ranked search results set.

The following discussion describes exemplary embodiments as a combination of one or more of three components and in the context of client appliance(s) and ASP host server(s). It is not the intention of this discussion or the above discussion to limit the present invention to appliances and ASP host servers, but rather is illustrative and one having ordinary skill in the art will appreciate that other embodiments may not include an appliance or ASP. By way of introduction, at least one exemplary embodiment may provide for one or more appliances and one or more host servers within a network. The one or more host server may be referred to as the first server on a network and the one or more appliances may be referred to as a second appliance server on a network. All servers may be accessible by one or more clients. At least one other exemplary embodiment may allow for the separation and management of the components of a system contained behind a secure access point on a network, such as a firewall, and components of a system contained on a publicly accessible network. The components of the system may include one or more of a software application, discrete document collections and confidential information created by a user on a client computer.

One exemplary purpose of an exemplary embodiment may be to allow for the separation of software programs and databases between a publicly accessible first server and the second appliance server that would preferably be located behind a secure access point such as a firewall. At least one exemplary embodiment may ensure a physical separation between the first server and the second appliance server, which contain the confidential data, while still allowing the client to access the first server for software programs or data not contained on the second appliance server.

A first component of an exemplary embodiment may provide for a first server characteristic of an Application Service Provider (ASP) system architecture wherein a software application and database resides on a host server (ASP), and may be accessible, usually by subscription, by one or more client users on a network. A first server may contain at least a computer program (software application), a database collection of documents, and a search index that may include at least a latent semantic concept database, together called an ASP model.

A client may access the first server directly via a network such as the Internet, and make use of the software, databases and search documents as intended by the ASP model. An ASP model may be preferable when: (a) the document collection is great in size so that the duplication of the entire document collection on a client or on a server local to the client can be cost prohibitive; and (b) the software incorporates various programs and is undergoing continued enhancement so that installation of the software on a client or on a server local to the client would lose the cost and efficiency benefits normally associated with subscribing to an ASP provider.

A second component of an exemplary embodiment of the present invention may provide for the distribution of various programs of a single ASP software application across one or more servers within a network, thus, it may allow for a system architecture to be configured so that the programs required to manage confidential data on the second appliance server interface with the programs of the same software application installed on the ASP first server as if the entire software application was installed on only the ASP first server. For example, a user may want to use a program to search confidential documents contained on the appliance server, such documents preferably include a less extensive collection than that of which may be contained on the first server. Further, the user may want to use a single search query and simultaneously search any one or more collections of documents contained on any server within a network. In either case, the client may desire the presentation of a single page that lists the search results from all databases on all servers; such listing can be ordered according to the most relevant documents responsive to a search query.

Another exemplary embodiment of the present invention may provide for the distribution of the concept database of the first server to one or more appliance servers connected to a network. More specifically, the concept database, which may be the product of a latent semantic pseudo vector matrix indexing of a relatively extensive document collection contained on the first server. The concept database may be a neural net that can learned various concepts contained in documents contained on the first server, and can be configured to relevancy rank the documents in a collection according to how closely the individual documents compare with the pseudo vector(s) of a search query.

Concept databases may have increased reliability within an extensive and defined collection of documents since the database is said by some to “understand” a substantial amount of the possible concepts expressed in the documents, and, therefore, may be capable of establishing an intelligent ranking of the documents in response to any search query. Such collections of documents, for example, may be patent literature, technical journal articles related to semiconductor manufacturing, or disease and pharmaceutical remedy databases and the like known to one having ordinary skill in the art.

The concept database contained on the ASP first server may be of economic value to a client when the client has developed a less extensive document collection, the sorting of which can rely on a possibly more intelligent latent semantic understanding of the subject matter. In other words, at least one embodiment of the present invention can allow the client to search a non-public collection of documents contained on a second appliance server, and potentially receive a relevancy ranking of the search results list substantially similar to relevancy ranking that may have been obtained if the non-public collection was a part of the more extensive collection contained on the first server.

As one non-limiting example, patent attorneys or agents working on a network within a company may search their collection of invention disclosures in an effort to identify those that may be potentially patentable. By simultaneously or, alternatively, sequentially searching their invention disclosure database that can be contained on the second appliance server, along with searching, for example, an international patent database contained on the ASP first server, the attorney or agent may be able to view one or more lists (optionally, combined into a single result set) or search results from all servers accessed. This may allow for the identification of any patent publications (e.g., granted patents or published applications) that are most relevant to the invention disclosure being researched. This process, according to at least one exemplary embodiment, may occur without confidential invention disclosure information leaving the application server located behind the security access point.

Likewise, as another non-limiting example, a physician in a medical institution may elect to search all patient medical histories contained on the institution's appliance server database against a relatively more extensive publicly accessible database of medical literature (e.g., identifying known diseases and treatments). In this non-limiting example, the physician may search the appliance database(s) as well as the ASP first server database(s) to identify how a patient listed on their appliance server may respond to a treatment as disclosed on the ASP first server.

Thus, one exemplary embodiment of the present invention may allow for increased configuration flexibility for a user because a collection of programs and databases may be accessible from the client on one server, while the same or different collection of programs and databases is simultaneously accessible on one or more different servers. Further, at least one other exemplary embodiment including the installation on one or more second appliance servers within a network a duplicate, or at least a reasonable facsimile of the concept database that can be contained on the ASP first server, may allow the client to search a less extensive collection on the appliance server with increased confidence and increased results relevancy ranking and precision.

A third component of an exemplary embodiment of the present invention may provide for the creation and storage of user created data. User created data may be stored upon the first server or a second appliance server including for example, but not limited to, metadata attached to documents stored in a database, usage logs, client preferences and user's personal files and workspace records.

In order to put the security responsibility and control of such confidential data in the hands of the information steward, at least one exemplary embodiment may allow for the storage of such data upon a second appliance server placed behind a secure access point, such as a firewall, within a network. One exemplary embodiment of the present invention may allow the appliance server to communicate with the ASP first server, while it can allow the appliance server steward to apply its own additional security measures to potentially minimize exposure of the data stored upon the appliance server to unauthorized access.

The previously disclosed first, second and third components together comprise at least one embodiment of the system according to the present invention, but a combination of the first and second components, the first and third components, or the second and third components together may similarly comprise the entirety of embodiments of the system according to the present invention.

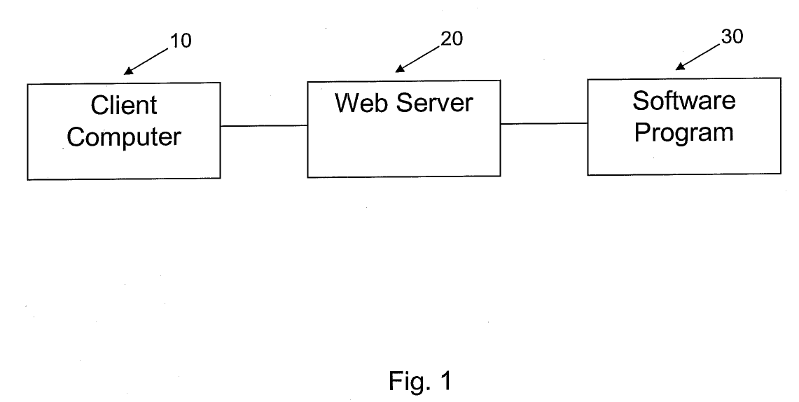

Now referring generally to FIGS. 1-10, at least one exemplary embodiment of the present invention may include a software application on a server accessible by a remote client on a network. In the preferred ASP model, the client and server are connected to a network, preferably the Internet. For this reason, FIG. 1 shows a client 10 connecting through a web browser to a web server 20 to a remote software program 30.

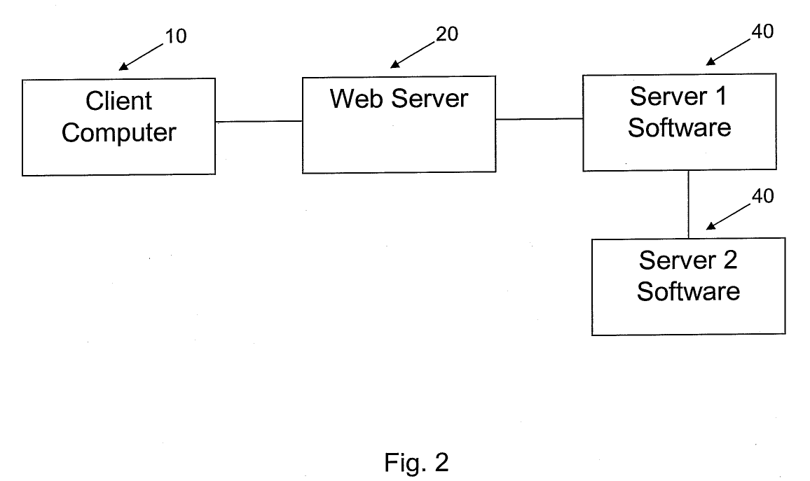

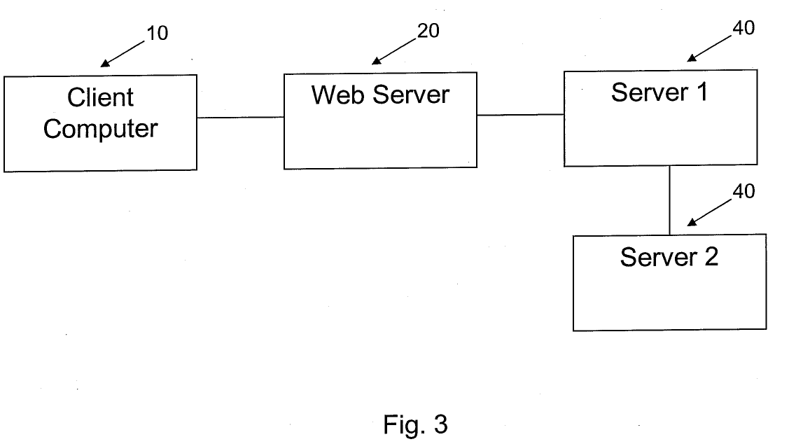

FIG. 3 expands on the simplified FIG. 1 by showing a more detailed diagram connecting a client 10 through a web server 20 to more than one server 40, remotely located on a network. Although not shown in FIG. 3, the servers may include at least one of the following: (a) a database, (b) a software program; and (c) a means to search a database, as a few non-limiting examples. For example, FIG. 2 is a flowchart substantially similar to FIG. 3, but illustrates that software (one non-limiting example) that may or may not have common programs is contained on each of the one or more servers 40.

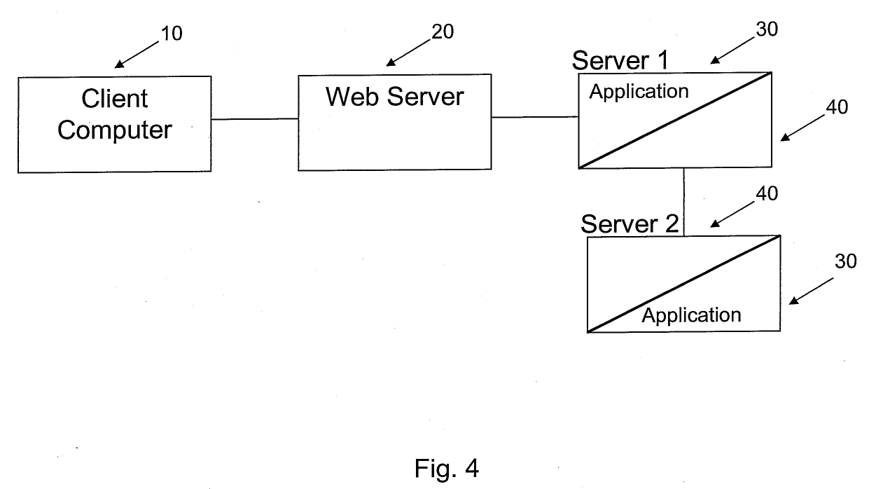

An exemplary architecture of the system can distribute some or all of the functionality of the software, database and search means typically residing on a single server across more than one server on the network. This system architecture is simplified in FIG. 4, illustrating server 1 that contains a database 40 and software program 30 as well as server 2 which also contains a database 40 and software program 30. The software program 30 on server 1 may be the same or different from the software program 30 on server 2. However, an embodiment of the present invention prefers that at least one software application is distributed across more than one server by complete duplication of all programs. Alternatively, the same or different programs may reside on server 1 and server 2, the programs together comprise the entire software application 30. As a non-limiting example, a user preferences file program may reside on server 1 while the remainder of the programs that comprise the software application reside on server 2. Together, the programs on server 1 and server 2 can deliver the complete envisioned functionality of the software application 30.

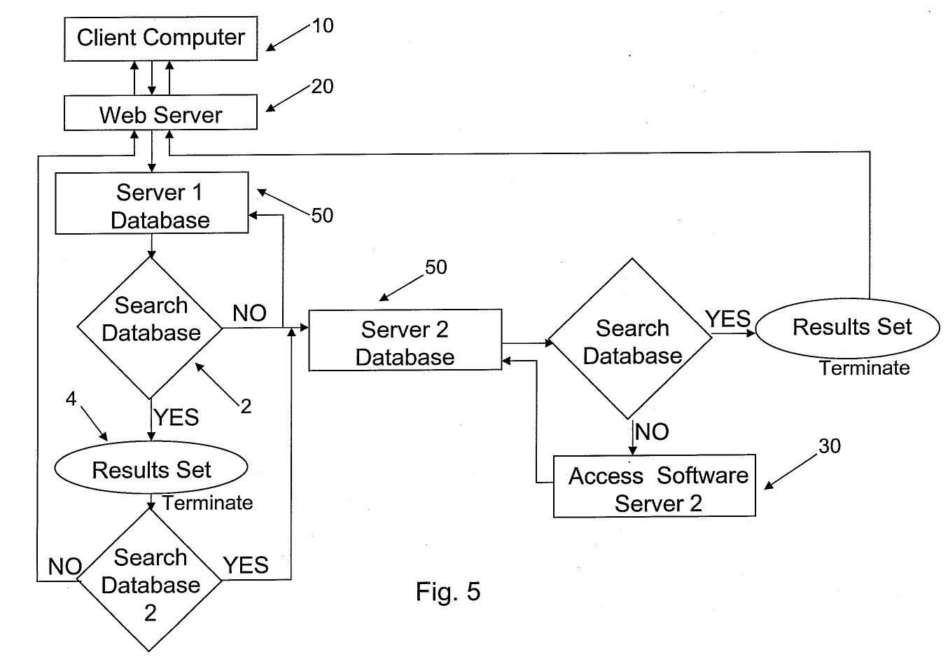

Embodiments of the present invention may allow a user to search a client database(s) located on the servers in the network. As shown in FIG. 5, by applying a search query at the client 10, the query will be applied to multiple databases 50 on one or more servers as specified by the user. If the search query is applied to a single database, as shown on server 1 with database 50, a single search 2 of the database 50 will return a single search results list 4 to the client 10.

If a search query is applied to more than one database, a number of search results lists equal to the number of databases may be returned. However, it may be preferred that the multiple lists be merged into a single search results list prior to returning the results to the client, preferably at or prior to the search results arriving at the web server 20. The merged search result list may be organized with documents responsive to the search query ordered with the more relevant documents presented at the top of the merged search results list and the less relevant documents presented at the bottom of the merged list.

Nevertheless, the difficulty in accurately ranking documents from different sized heterogeneous databases against one another is discussed above. The problem can arise when two different databases containing a different document collection is indexed. Although an index may be able to map the relationships between the documents within a given database, that same index may not enjoy the ability of indexing a document collection located on a different server.

Embodiments of the present invention may overcome this difficulty by first indexing a more extensive document collection that may have a corpus of a substantial collection of literature of a particular type, theme, content or format (e.g., a first document collection). As an example, this definitive index may have mapped a substantial volume of patent documents. Exemplary embodiments contemplate the mapping of a substantially amount, if not all, of the concepts contained in documents into a latent semantic concept database. Once a substantial amount of documents within a first document collection are mapped within a concept database, the relationships between the documents may be negligibly affected by the addition of a decreased number of documents to the first collection.

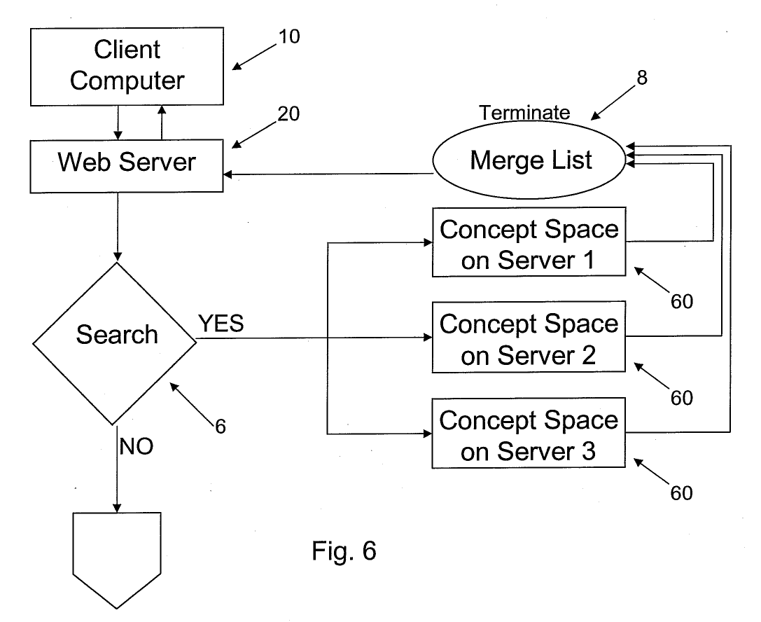

In FIG. 6, the concept database is shown as being distributed to more than one server 60. The distributed concept database may either be a mirrored concept database that ensures an exact duplicate of the first concept database or one or more second servers may contain a concept database that is a reasonable facsimile of the first concept database. Two or more document collections may reside on various servers in the network. In a preferred network structure, all document collections other than the first document collection will contain substantially less documents than the first collection. As documents in the various databases are indexed against the first concept databases, or a reasonable facsimile of the first concept database, they can receive a definitive score characterized by a pseudo vector. Regardless of on which server a document is located, the score it receives is substantially the same as if that document resided on the first server and was indexed against the first concept database.

An exemplary object of this distributed database component of the present invention is to assist in ensuring that a search 6 performed against different document collections contained on different servers 60 in a network may produce a search results list from each server, such lists can contain documents occupying a position in the list as determined by mapping the distance of the pseudo vector for each document against the pseudo vector of the search query. The multiple results lists are then merged 8 into a single list so that all of the documents are reorganized relative to each other as determined by their relative scores.

The search method of at least one exemplary embodiment of the present invention may be characterized by a concept database and relevancy ranking intelligence that may be distributed to other servers containing collections of documents that can be similar by type to the document collection on the first server. Without distribution, a database containing one document would most likely have no score since there is no comparable document against which to map any attributes of the lone document. Therefore, a single result from one server may not accurately be merged, based on relevancy, with the results list from a database containing, for example, millions of documents.

By distributing the intelligent concept database across more than one server in a network, a user may modify a private collection of documents on one server, those documents can be assigned a pseudo vector similar to the pseudo vector it would have been assigned if the document resided on the first server. This can allow the user to receive a relevant search results list when searching a private collection as small as one document, and searching a more extensive collection of documents located remotely on a first server.

A network may contain multiple servers, and upon those servers one or more versions or configurations of a common database and software application can be installed as described above.

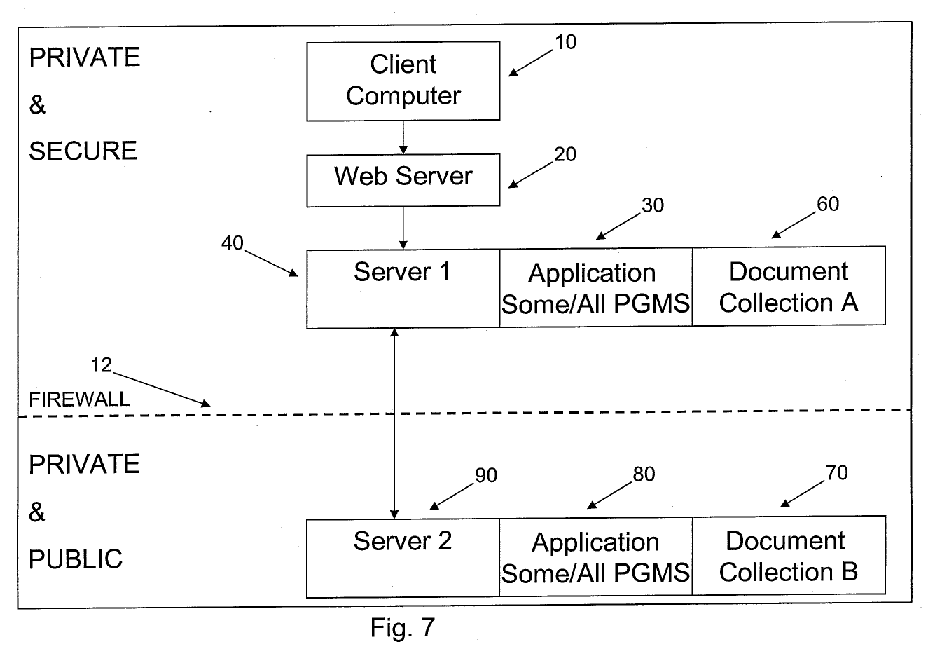

FIG. 7 shows this configuration, with the added clarification that server 40 or more may reside behind a firewall 12, and another server 90 or more may reside on the public side of a firewall. Server 1, 40 shows that it contains programs of a software application 30, plus a concept database and document collection 60. Server 2, 90 similarly shows that it contains programs of a software application 80 which may contain a different set of programs or functionality when compared to the software application 30, but is nevertheless a collection of programs that comprise the same software application 30.

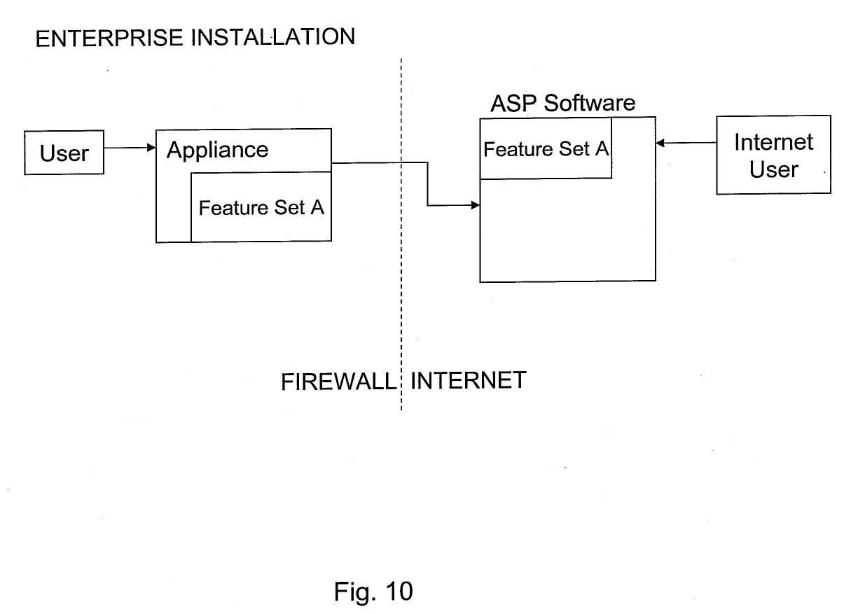

One can readily see that a client 10 accessing a network containing server 1, 40 and server 2, 90 may invoke a search of any of the databases 60 and 70, or any of the desired software features 30 and 80 as needed to obtain the intended result. Likewise, FIG. 10 shows one appliance or more accessing a feature set of software residing on an ASP host server where the appliance is behind a firewall and the ASP software is accessed via the Internet.

In order to help a user maintain the secrecy of their user files, user activity logs or other confidential data and the like generated with the use of the software application, at least one exemplary embodiments of the present invention can make a provision to store such confidential information on server 1, 40 which is located behind a firewall or other suitable protected access point.

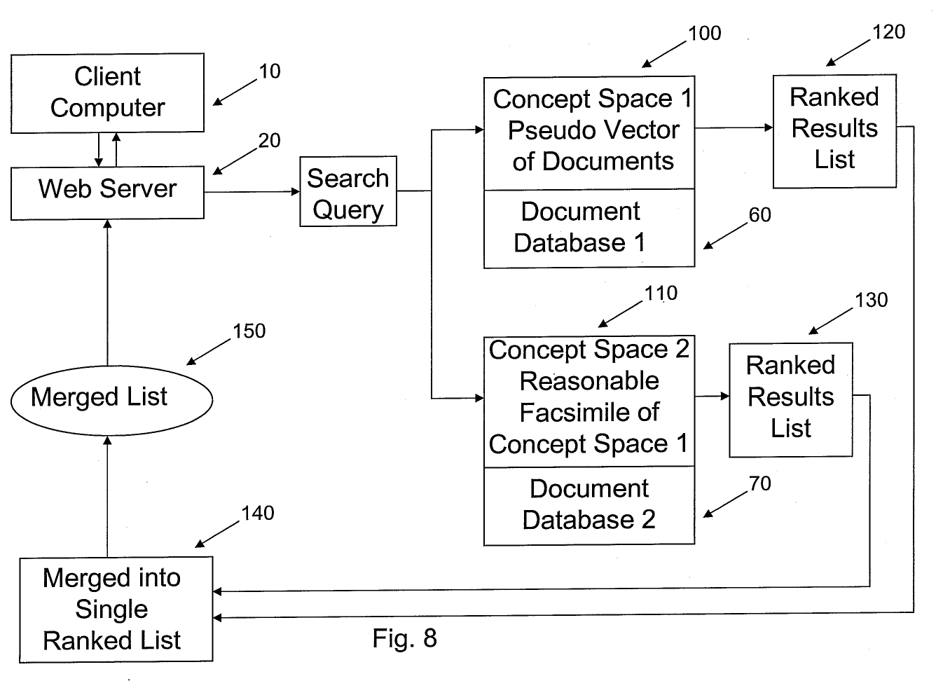

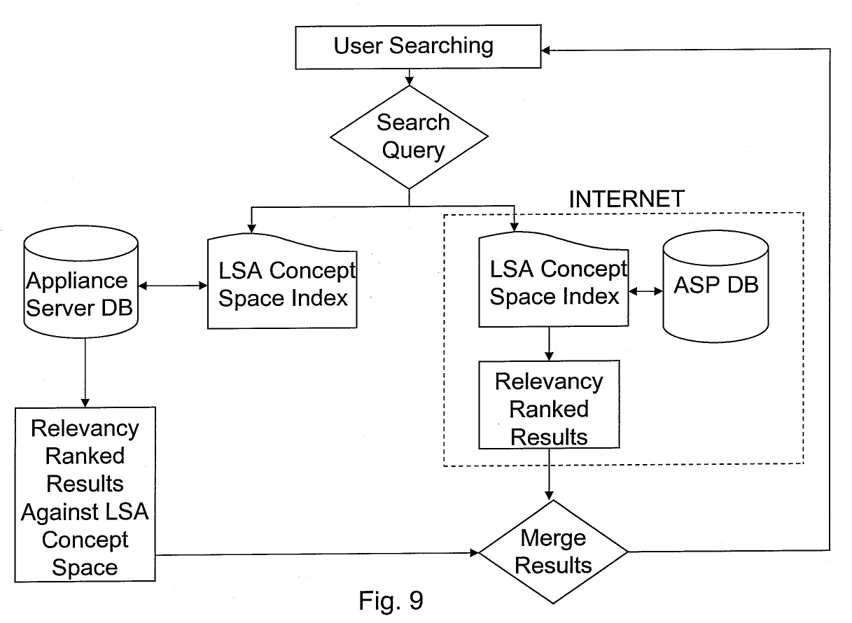

FIGS. 8 and 9 show an expanded configuration of the system, although it is not intended to limit the present invention. It is reasonable, and in practice expected, that a considerably more complex system configuration as well as more complex distribution of a large number of objects or features of the software application or concept database are possible. For brevity of this application, it does not describe every possible variation or combination.

Referring specifically to FIG. 8, the distribution of a concept database across multiple servers 100, 110 may allow different documents contained in different databases 60, 70 to be searched, thereafter the search results can be presented in multiple relevancy ranked lists 120, 130. The ranking of the disparate lists can be based upon the proximity of the pseudo vector of each document to the pseudo vector of the single search query. The multiple lists can then be optionally merged 140, accurately organizing all documents from all results lists into a single relevancy ranked merged list 150. The merged single results list may then displayed on the client 10, preferably within a web browser.

Because of the large number of combinations and relative scale of the combinations of the number of servers on a network, the number of document collections, and the number of documents within those collections residing on one or more servers, and the large number of programs that make up an enterprise software application, with one or more of those programs residing or coupled to directly or indirectly one or more servers in a network, one skilled in the art will be able to readily envision new variations of the present invention which are not disclosed in this application. However, preferred and exemplary embodiments are not intended to limit the number of configurations of a distributed database and computer program residing on servers within a network.

Further exemplary embodiments of the present invention may include a method for searching a plurality of databases which are distributed and accessible to a client through one or more search servers comprising, (a) a first server containing a first semantic vector space computed by indexing a first data center comprised of one or more databases, (b) one or more second servers each containing a distributed version of the first semantic vector space, (c) first data center containing documents indexed against a first semantic vector space, (d) one or more second servers containing documents indexed against the distributed version of the first semantic vector space, (e) the application of a search query from a client to a first, or a distributed version of the first semantic vector spaces, (f) the relevancy of the search results list from each server, computed at each semantic vector space on each server, and (g) the combining of the individual relevancy-ranked results lists delivered to a client as a single results list organized by relevancy. Another exemplary embodiment includes a method of searching as described above and also includes eliminating duplicate documents contained in multiple results lists prior to displaying only one said document in a combined results list.

Yet another exemplary embodiment includes a method of distributing a software application across a network may include: (a) a first configuration of a software application on a first server provides a standardized feature set to all clients wherein one or more feature sets may allow the client to store upon the first server information created by the client: and (b) one or more second configurations of the software application on a first server that may provide for a reduced feature set to all clients and one or more feature sets not accessed by the client from a first server are provided to the client from one or more second servers wherein the feature sets contained in a second server allow the client to store upon a second server information created by the client.

In another exemplary embodiment, a method of distributing a software application across a network may include one or more configurations of a software application on a first server provides for a reduced feature set to all clients and one or more feature sets not accessed by the client from a first server are provided to the client from one or more second servers wherein the feature sets contained in a second server allow the client to store upon a second server information created by the client.

In another exemplary embodiment, a method of searching a plurality of databases wherein (a) client accesses certain features of a feature set of a distributed software application, (b) obtains access to a search engine, (c) applies a search query to the search engine that distributes the query to one or more distributed servers that employ various features of a feature set of the distributed software, (d) record upon one server information created by a client, and (e) deliver to the client a single relevancy ordered list of search results computed at one or more servers upon which the search query was applied.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for distributing more than one concept database in a network, comprising:
a network having a secure access point, the network being accessible to one or more clients;
at least one host server accessible to the client via the network, the at least one host server having a concept database and at least one of a database, a software application, an electronic document collection and a search functionality; and
at least one local server configured to store user created data determined to be sensitive behind the secure access point accessible to the client via the network, the at least one local server having a distributed version of the concept database and at least one of a database, a software application, an electronic document collection and a search functionality, whereby the client has trans-secure-access-point communication with the at least one host server and the at least one host server is operatively interfaced with the at least one local server.

2. The system of claim 1, wherein the concept database is a semantic vector space resulting from latent semantic pseudo vector matrix indexing of an electronic document collection contained on the at least one host server.

3. The system of claim 2, wherein the distributed version of the concept database is a substantial facsimile of the semantic vector space.

4. The system of claim 1, wherein the secure access point is a firewall.

5. The system of claim 1, wherein the at least one host server is hosted by an application service provider (ASP).

6. The system of claim 1, wherein the at least one local server is one or more appliances.

7. The system of claim 1, wherein the at least one host server contains an electronic document collection having public patent-related documents.

8. The system of claim 7, wherein the at least one local server contains an electronic document collection having non-public patent-related documents.

9. The system of claim 1, wherein at least a portion of the network comprises the Internet.

10. A method of distributing a concept space within a network, comprising:
providing at least one host server containing at least one primary document collection;
providing a first concept space contained on the at least one host server, wherein the first concept space results from indexing the at least one primary document collection;
providing at least one client server containing at least one secondary document collection; and
providing one or more second concept spaces substantially similar to the first concept space, the one or more second concept spaces contained on the at least one client server; wherein the at least one secondary document collection is indexed against the one or more second concept spaces.

11. The method of claim 10, wherein the first concept database is a semantic vector space resulting from a latent semantic pseudo vector matrix indexing of the at least one primary document collection contained on the at least one host server.

12. The method of claim 11, wherein the one or more second concept spaces are one or more distributed version of the semantic vector space.

13. The method of claim 10, wherein the at least one client server is provided behind a secure access point.

14. The method of claim 10, wherein the at least one host server is hosted by an application service provider (ASP).

15. The method of claim 10, wherein the at least one client server is one or more appliances.

16. A method of searching a plurality of databases which are distributed and accessible to a client through one or more search servers, comprising:
accessing a first search server containing a first document collection having one or more first databases and containing a first semantic vector space computed by indexing the first document collection;
accessing one or more second search servers containing at least one second document collection comprised of one or more second databases, the one or more second search servers also containing one or more distributed versions of the first semantic vector space, wherein the at least one second document collection is indexed against the one or more distributed versions of the first semantic vector space;
submitting a search query from a client to the first search server and the one or more second search servers;
returning one or more first relevancy-ranked search result sets to the client from the one or more databases on the first search server computed at the first semantic vector space; and
returning one or more second relevancy-ranked search result sets to the client from the one or more databases on the one or more second search servers computed at the one or more distributed versions of the first semantic vector space.

17. The method of claim 16, further comprising:
combining the one or more first relevancy-ranked sets and the one or more second relevancy-ranked sets into a third relevancy-ranked set organized by relevancy.

18. The method of claim 17, wherein the one or more second servers are behind a secure access point.

19. The method of claim 18, wherein the one or more second servers are configured to store at least one user created data determined to be sensitive.

20. The method of claim 16, wherein the first search server is hosted by an application service provider (ASP)

21. The method of claim 16, wherein the one or more second search servers are one or more search appliances.

22. The method of claim 16, wherein the first document collection has a plurality of public patent-related documents.

23. The method of claim 16, wherein the at least one second document collection has at least one non-public patent-related documents.

24. The method of claim 16, wherein the one or more second relevancy-ranked search results sets each have one or more relevancy ranks substantially similar to one or more theoretical relevancy ranks that would be obtained if the at least one second document collection was included in the first document collection and indexed by the first semantic vector space.

25. The method of claim 16, further comprising:
displaying the combined third relevancy-ranked set to a user via a web browser.
